(19) United States
(12) Patent Application Publication
(10) Pub. No.: US 2024/0406551 A1
(43) Pub. Date: Dec. 5, 2024

(54) BORESCOPE CAMERA WITH TEMPERATURE SENSING CAMERA HEAD

(71) Applicant: MILWAUKEE ELECTRIC TOOL CORPORATION, Brookfield, WI (US)

(72) Inventor: Francisco J. Hernandez, Brookfield, WI (US)

(21) Appl. No.: 18/680,686

(22) Filed: May 31, 2024

Related U.S. Application Data
(60) Provisional application No. 63/505,595, filed on Jun. 1, 2023.

(51) Int. Cl. H04N 23/667; G01K 3/00; H04N 23/50

(52) U.S. Cl. CPC H04N 23/667; H04N 23/555; G01K 3/005

(57) ABSTRACT

An imaging system is described that includes a control device and an imaging module coupled to the control device. The imaging module includes a temperature sensor configured to sense a temperature of at least a portion of the imaging module. The control device includes one or more electronic processors that are configured to monitor the temperature sensed by the temperature sensor, determine whether the temperature exceeds a first predetermined threshold, and generate a warning in response to determining that the temperature exceeds the first predetermined threshold. The one or more electronic processors are also configured to determine whether the temperature exceeds a second predetermined threshold, and power down the imaging module in response to the temperature exceeding the second predetermined threshold.

### CROSS-REFERENCE TO RELATED APPLICATIONS

This application claims priority to, and the benefit of, U.S. Provisional Patent Application No. 63/505,595, filed Jun. 1, 2023, the entire contents of which are hereby incorporated by reference in their entirety.

### FIELD

The present application relates to an imaging device, such as a visual inspection device.

### BACKGROUND

Inspection devices, such as borescopes, may often require the imaging device (e.g., camera) to be located in confined spaces that may have a high ambient temperature. These high temperatures may damage the imaging devices if the temperature causes the operating temperatures of components within the imaging devices to rise above their operating limits. Thus, regulation of these components based on temperature may prevent damage to various components within imaging devices.

### SUMMARY

In one embodiment, an imaging system is described that includes a control device and an imaging module coupled to the control device. The imaging module includes a temperature sensor configured to sense a temperature of at least a portion of the imaging module. The control device includes one or more electronic processors that are configured to monitor the temperature sensed by the temperature sensor, determine whether the temperature exceeds a first predetermined threshold, and generate a warning in response to determining that the temperature exceeds the first predetermined threshold. The one or more electronic processors are also configured to determine whether the temperature exceeds a second predetermined threshold, and power down the imaging module in response to the temperature exceeding the second predetermined threshold.

In another embodiment, a process for controlling an imaging system is described. The process includes monitoring a temperature sensed by a temperature sensor of an imaging device, determining whether the temperature exceeds a first predetermined threshold, and generating a warning in response to determining that the temperature exceeds the first predetermined threshold on a display of a control device coupled to the imaging device. The process also includes determining whether the temperature exceeds a second predetermined threshold and removing power from the imaging device in response to the temperature exceeding the second predetermined threshold.

In another embodiment, an inspection device is described. The inspection device includes a control unit, an inspection cable coupled to the control unit at a proximal end, and an imaging device coupled to a distal end of the inspection cable. The imaging device includes a temperature sensor to sense a temperature of at least a portion of the imaging device. The control unit includes one or more electronic processors configured to monitor the temperature sensed by the temperature sensor, determine whether the temperature exceeds a first predetermined threshold, and generate a warning in response to determining that the temperature exceeds the first predetermined threshold. The control unit is also configured to determine whether the temperature exceeds a second predetermined threshold and power down the imaging device in response to the temperature exceeding the second predetermined threshold.

### BRIEF DESCRIPTION OF THE DRAWINGS

FIG. 1 is a perspective view of an imaging system, according to some embodiments.

FIG. 2 is a side view of an imaging system camera module, according to some embodiments.

FIG. 3 is a top view of the imaging system camera module of FIG. 2, according to some embodiments.

FIG. 4 is a block diagram of a controller of the imaging system of claim 1, according to some embodiments.

FIG. 5 is a connection diagram of a connector of the imaging system camera module of FIG. 2, according to some embodiments.

FIG. 6 is a flow chart illustrating a process for controlling the imaging system, according to some embodiments.

### DETAILED DESCRIPTION

Before any embodiments are explained in detail, it is to be understood that the embodiments are not limited in their application to the details of construction and the arrangement of components set forth in the following description or illustrated in the following drawings. The embodiments may include other constructions and the arrangements of components and may be practiced or carried out in various ways. Also, the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software-based devices, as well as a plurality of different structural components may be utilized to implement the disclosed embodiments. Furthermore, and as described in subsequent paragraphs, the specific configurations illustrated in the drawings are intended as example embodiments and that other alternative configurations are possible. The terms “processor” “central processing unit” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

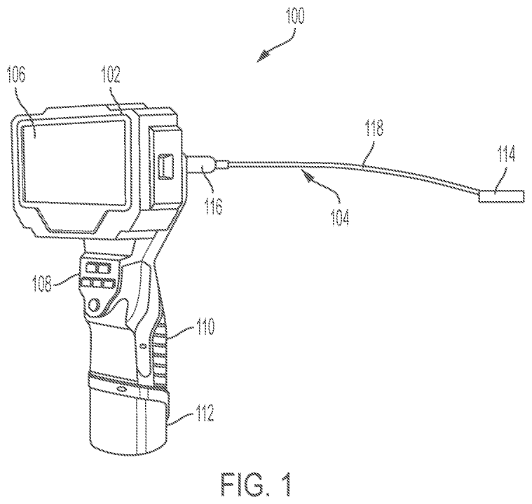

FIG. 1 is a system view of a borescope system 100, having a control device 102 and a camera module 104 attached to the control device 102. The control device 102 includes a display portion 106, a user interface 108, a handle portion 110, and a removable battery pack 112. The camera module 104 includes a camera portion 114, a connector 116, and a cable portion 118 coupling the connector 116 and the camera portion 114.

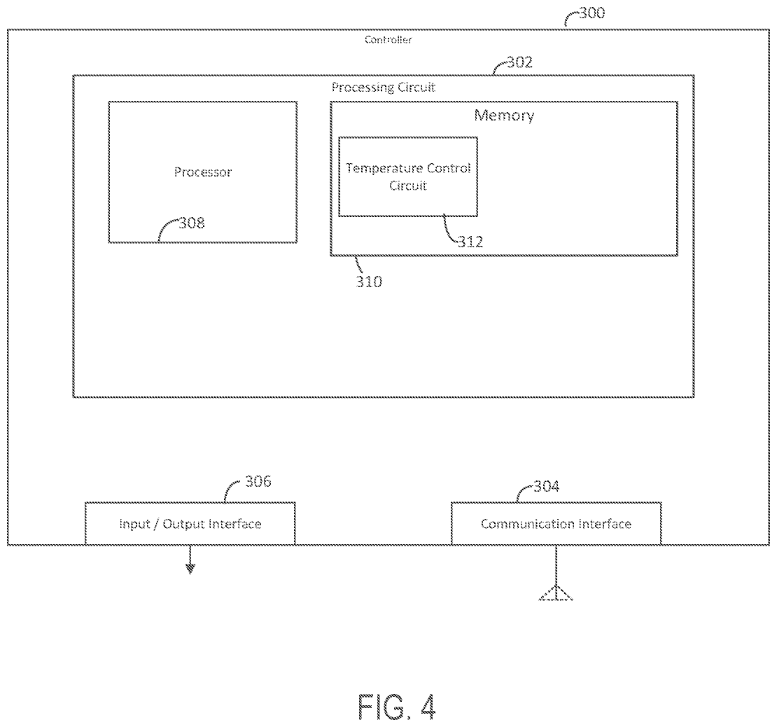

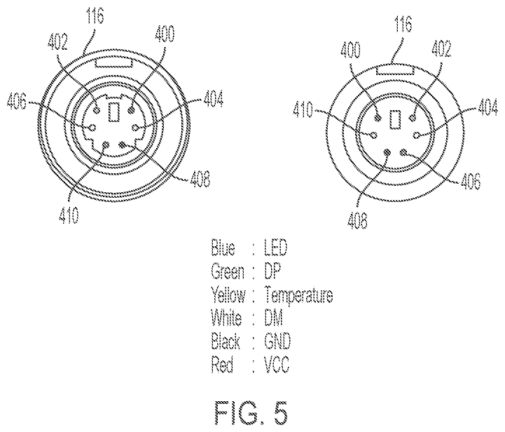

The display portion 106 is configured to display images to a user. For example, the display portion 106 may be configured to display an image capture by the camera portion 114. Additional information, such as image metadata, temperature, and or other parameters provided by the camera portion 114 may be displayed by the display device. The user interface 108 may include one or more user inputs, such as push-buttons, touchscreens, scroll wheels, knobs, joysticks, and/or any other user input required for a given application. In some examples, a user may be able to access one or more menus associated with the control device 102 and/or the camera module 104, which may be displayed on the display portion 106. As described in more detail in FIG. 4, below, the control device 102 includes one or more controllers 300 configured to perform various operations associated with the control device 102, such as process data from the camera module 104, interpret user inputs, control one or more aspects of the camera module 104, and/or any other functions required for a given application.

The handle portion 110 may house various componentry of the control device 102, and further includes a cavity for accepting the rechargeable battery pack 112. The rechargeable battery pack 112 may be a power tool battery, such as 12V lithium-ion battery pack from Milwaukee Tool®. However, other battery voltages, such as 3.3V, 18V, 24V, or other voltage required for a given application are also contemplated. Further, other battery chemistries, such as lithium-iron phosphate, nickel cadmium, alkaline, and/or other battery chemistries required for a given application are also contemplated.

As described above, the camera module 104 includes a camera portion 114 at a first end of the cable portion 118. The camera portion 114, as will be described in more detail below, may include one or more imaging sensors, as well as other sensors, such as light sensors, microphones, temperature sensors, or other sensors as required for a given application. The camera portion 114 may further include other components, such as one or more LEDs for providing illumination for the image sensors. The camera module 104 also includes a connector 116 coupled at a second end of the cable portion 118, proximal to the camera portion 114. The connector 116 may be a six-pin twist-lock connector. However, other connector types are contemplated as required for a given application. The connector 116 is configured to interface with a corresponding connection port on the control device 102.

The cable portion 118 may generally be a semi-rigid cable allow for manipulation of the camera portion 114 within an enclosed space. However, in other embodiments, the cable portion 118 may be more pliable or more rigid, as required for a given application. The cable portion 118 may be variable in length depending on a desired application.

While the above camera module 104 is described as being used with a borescope-type control device 102, it is understood that other imaging devices, such as pipeline inspection devices, may also be compatible with the camera module 104.

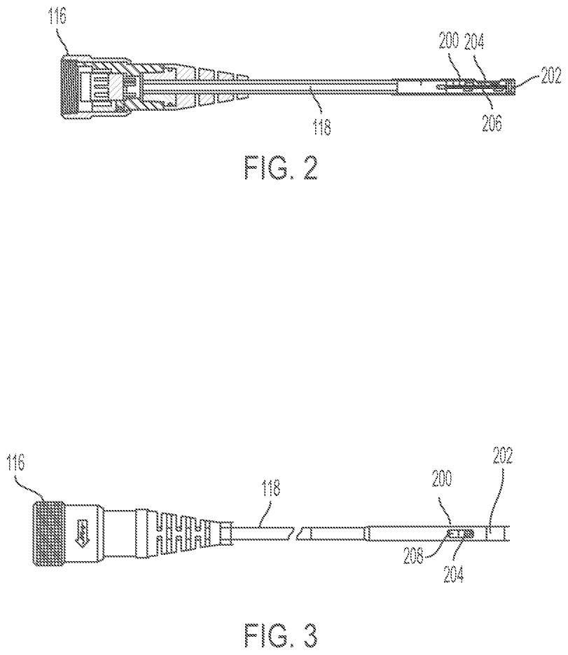

Turning now to FIGS. 2 and 3, the camera module 104 is shown in greater detail. FIG. 2 is a side view of the camera module 104 and FIG. 3 provides a top view of the camera module 104. The camera portion 114 includes a housing 200, a front facing image sensor 202, a top mounted image sensor 204, and a temperature sensor 206. The image sensors 202, 204 may generally be 1/9″ CMOS digital image sensors. However, other image sensor types are contemplated as required for a given application. In one embodiment, the image sensors 202, 204 may be high-definition image sensors capable of a resolution of 720p at 25 frames per second (FPS). However, other resolutions and/or framerates are also contemplated as required for a given application. The image sensors 202, 204 may generate outputs in an MJPEG format, a YUV format, and/or other format as required for a given application.

An LED 208 is also incorporated into the camera portion 114 and is able to provide illumination for the image sensors 202, 204.

The temperature sensor 206 may be configured to monitor a temperature at the camera portion 114. In some examples, the temperature sensor 206 may be configured to detect a temperature of one or more of the image sensors 202, 204. In other examples, the temperature sensor 206 monitors a general temperature at the housing 200. In one embodiment, the temperature sensor 206 is a negative temperature coefficient (“NTC”) temperature sensor. However, other temperature sensor types, such as positive temperature coefficient (“PTC”) sensor, a thermistor, and/or other temperature sensor type as required for a given application. The temperature sensor 206 may be configured to provide temperature data to the control device 102, such that the control device 102 can control and/or adjust the operation of the camera module 104, as will be described in more detail below. In one embodiment, the temperature sensor 206 has a temperature range between-40C to 100C.

Turning now to FIG. 4, a block diagram illustrating the controller 300 is shown, according to some embodiments. The controller may include a processing circuit 302, a communication interface 304, and an input/output (“I/O”) interface 306. The processing circuit 302 includes one or more electronic processors 308 and a memory 310. The processing circuit 302 may be communicably connected to one or more of the communication interface 304 and the I/O interface 306. The electronic processor 308 may be implemented as a programmable microprocessor, an application specific integrated circuit (ASIC), one or more field programmable gate arrays (FPGA), a group of processing components, or with other suitable electronic processing components.

The memory 310 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 310 may include database components, object code components, script components, or other types of code and information for supporting the various activities and information structure described in the present application. According to one example, the memory 310 is communicably connected to the electronic processor 308 via the processing circuit 302 and may include computer code for executing (for example, by the processing circuit 302 and/or the electronic processor 308) one or more processes described herein.

The communication interface 304 is configured to facilitate communication between the control device 102 and one or more external devices or systems, such as computers, smart phones, dedicated display devices, and/or other devices as required for a given application. In one embodiment, the communication interface may be, or include, wireless communication interfaces (for example, antennas, transmitters, receivers, transceivers, etc.) for conducting data communications between the control device 102 and one or more external devices, such as those described above. In some embodiments, the communication interface 304 utilizes one or more wireless communication protocols, such as cellular (3G, 4G, 5G, LTE, CDMA, etc.), Wi-Fi, LoRa, LoRaWAN, Z-wave, Thread, and/or any other applicable wireless communication protocol.

The I/O interface 306 may be configured to interface directly with one or more devices, such as a power supply, the camera module 104, etc. In one embodiment, the I/O interface 306 may utilize general purpose I/O (GPIO) ports, analog inputs, digital inputs, etc.

As described above, the memory 310 may be configured to store various processes, layers, and modules, which may be executed by the electronic processor 308 and/or the processing circuit 302. In one embodiment, the memory 310 includes a temperature control circuit 312. The temperature control circuit 312 may be configured to perform one or more operations to monitor and regulate a temperature of the one or more components of the borescope system 100, such as the camera portion 114.

Turning now to FIG. 5, a pin-out schematic of the connector 116 is shown, according to some embodiments. As described above, the connector 116 is a six-pin connector, however other connector types are contemplated. The connector may include an LED control pin 400, a positive data pin 402, a temperature sensor pin 404, a negative data pin 406, a ground pin 408, and a power in pin 410. However, in other embodiments, more or fewer pins may be used in the connector 116, as required for a given application.

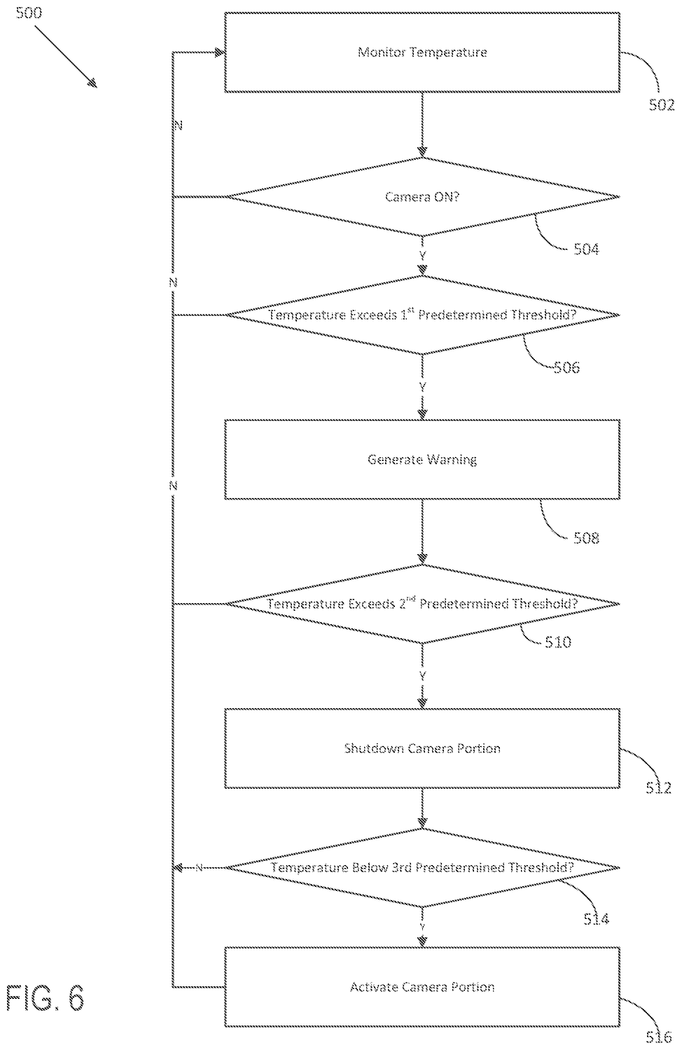

Turning now to FIG. 6, a flow chart is shown illustrating a process 500 for controlling an imaging device, such as borescope system 100, based on temperature data associated with the camera module, such as camera module 104. In one embodiment, the process 500 is performed by the control device 102, or more specifically by the controller 300 within the control device. However, it is contemplated that other imaging devices may also be used to perform the process 500. At process block 502 the control device 102 monitors a temperature of the camera module 104 provided by a temperature sensor, such as temperature sensor 206, described above. At process block 504, the control device 102 determines whether the one or more imaging devices, such as imaging sensors 202, 204 are ON (e.g., providing image data). In response to determining that the imaging devices are not ON, the control device 102 continues monitoring the temperature at process block 502. In response to determining that the imaging device are ON, the control device 102 determines whether the temperature data indicates that the temperature of the camera portion 114 exceeds a first predetermined threshold at process block 506. In one embodiment, the first predetermined threshold is 75° C. However, values of more than 75° C. or less than 75° C. are also contemplated as required for a given application.

In response to determining that the temperature does not exceed the first predetermined threshold, the control device 102 continues monitoring the temperature at process block 502. In response to determining that the temperature exceeds the first predetermined value, a warning message is provided to a user at process block 508. In one embodiment, the warning message is displayed on a display, such as the display portion 106 described above. However, in other embodiments, various user interfaces may display the warning message. For example, in some examples, the control device 102 may include a wireless communication interface (not shown) that allows for the warning (or other) messages to be transmitted to a user device, such as a smartphone, tablet computer, dedicated device, and/or other user devices as required for a given application. At process block 510, the control device 102 determines whether the temperature exceeds a second predetermined value. In one embodiment, the second predetermined value may be 80° C. However, values of more than 80° C. or less than 80° C. are also contemplated.

In response to determining that the temperature does not exceed the second predetermined threshold, the control device 102 continues monitoring the temperature at process block 502. In response to determining that the temperature sensor does exceed the second predetermined threshold, the control module 512 deactivates the camera portion 114. In one example, deactivating the camera portion 114 includes removing power from the camera portion. In other examples, instructions may be sent to the camera portion to prevent operation of the components within the camera portion, such as the imaging sensors 202, 204, and or the LEDs 208. By preventing operation of the camera portion, damage due to overheating may be prevented.

The control device 102 then continues to monitor the temperature and determines whether the temperature falls below a third predetermined threshold at process block 514. The third predetermined threshold is less than the second predetermined threshold. For example, the third predetermined threshold may be 70° C. However, values greater than 70° C. or less than 70° C. are also contemplated as required for a given application. In response to the temperature being determined to not be below the third predetermined threshold, the control device 102 continues to monitor the temperature at process block 502. In response to the temperature being determined to be below the third predetermined threshold, the control device activates the camera portion at process block 516, and then continues monitoring the temperature at process block 502. Additionally, upon the temperature falling below the third predetermined threshold, the warning may be removed from the display of the control device 102.

Although the application has described in detail certain embodiments, variations and modifications exist within the scope and spirit of one or more independent aspects of the embodiments as described.

What is claimed is:

1. An imaging system:
a control device;
an imaging module coupled to the control device, wherein the imaging module includes a temperature sensor configured to sense a temperature of at least a portion of the imaging module;
the control device including one or more electronic processors configured to:
monitor the temperature sensed by the temperature sensor:
determine whether the temperature exceeds a first predetermined threshold;
generate a warning in response to determining that the temperature exceeds the first predetermined threshold;
determine whether the temperature exceeds a second predetermined threshold; and
power down the imaging module in response to the temperature exceeding the second predetermined threshold.

2. The imaging system of claim 1, wherein the first predetermined threshold is 75° C.

3. The imaging system of claim 1, wherein the second predetermined threshold is 80° C.

4. The imaging system of claim 1, wherein control device includes a display.

5. The imaging system of claim 4, wherein the warning is generated on the display of the control device.

6. The imaging system of claim 1, wherein the temperature sensor is a negative temperature coefficient (“NTC”) sensor.

7. The imaging system of claim 1, wherein the one or more electronic processors are further configured to:
determine whether the temperature is below a third predetermined threshold; and
power up the imaging module in response to the temperature being determined to be below the third predetermined threshold.

8. The imaging system of claim 7, wherein the third predetermined threshold is a temperature value less than the second predetermined threshold.

9. A method for controlling an imaging system, comprising:
monitoring a temperature sensed by a temperature sensor of an imaging device;
determining whether the temperature exceeds a first predetermined threshold;
generating a warning in response to determining that the temperature exceeds the first predetermined threshold on a display of a control device coupled to the imaging device;
determining whether the temperature exceeds a second predetermined threshold; and
removing power from the imaging device in response to the temperature exceeding the second predetermined threshold.

10. The method of claim 9, wherein the first predetermined temperature is 75° C.

11. The method of claim 9, wherein the second predetermined temperature is 80° C.

12. The method of claim 9, wherein the temperature sensor is at least one selected from a group consisting of a negative temperature coefficient (“NTC”) sensor, a positive temperature coefficient (“PTC”) sensor, and a thermistor.

13. The method of claim 9, further comprising:
determining whether the temperature is below a third predetermined threshold; and
applying power to the imaging device in response to the temperature being determined to be below the third predetermined threshold.

14. The method of claim 13, wherein the third predetermined threshold is a temperature value less than the second predetermined threshold.

15. An inspection device, comprising:
a control unit;
an inspection cable, wherein the inspection cable is coupled to the control unit at a proximal end; and
an imaging device coupled to a distal end of the inspection cable, the imaging device including a temperature sensor to sense a temperature of at least a portion of the imaging device;
wherein the control unit includes one or more electronic processors configured to:
monitor the temperature sensed by the temperature sensor:
determine whether the temperature exceeds a first predetermined threshold;
generate a warning in response to determining that the temperature exceeds the first predetermined threshold;
determine whether the temperature exceeds a second predetermined threshold; and
power down the imaging device in response to the temperature exceeding the second predetermined threshold.

16. The inspection device of claim 15, wherein the temperature sensor is configured to detect a temperature of one or more image sensors within the imaging device.

17. The inspection device of claim 15, wherein the temperature sensor is at least one selected from a group consisting of a negative temperature coefficient (“NTC”) sensor, a positive temperature coefficient (“PTC”) sensor, and a thermistor.

18. The inspection device of claim 15, wherein the one or more electronic processors are further configured to:
determine whether the temperature is below a third predetermined threshold; and
power up the imaging device in response to the temperature being determined to be below the third predetermined threshold.

19. The inspection device of claim 18, wherein the third predetermined threshold is a temperature value less than the second predetermined threshold.

20. The inspection device of claim 15, wherein the warning is displayed on a display of the control unit.
